(19) United States
(12) Patent Application Publication
(10) Pub. No.: US 2017/0199734 A1
(43) Pub. Date: Jul. 13, 2017

(54) SYSTEMS AND METHODS FOR VERSIONING HOSTED SOFTWARE

(71) Applicant: LIFE TECHNOLOGIES CORPORATION, Carlsbad, CA (US)

(72) Inventors: Amitabh SHUKLA, San Jose, CA (US); Yuandan LOU, Cupertino, CA (US); Brijesh KRISHNASWAMI, Foster City, CA (US)

(21) Appl. No.: 15/412,156

(22) Filed: Jan. 23, 2017

Related U.S. Application Data
(62) Division of application No. 14/032,396, filed on Sep. 20, 2013, now abandoned.
(60) Provisional application No. 61/704,085, filed on Sep. 21, 2012.

(51) Int. Cl. G06F 9/445; G06F 19/28; G06F 9/44

(52) U.S. Cl. CPC G06F 8/65; G06F 8/71; G06F 19/28

(57) ABSTRACT

Systems and methods for performing a validated analysis can include access to first and second versions of an analysis engine. The first version of the analysis engine can be used to perform a previously validated analysis. After the second version is made available, the first version can be continued to be used while the second version undergoes validation. The user can initiate a migration from the first version to the second version when the validation is complete. Access to both versions can be maintained for a period of time to allow users to migrate on their own schedule, and a common login interface can direct the user to a default version or allow the user to select an alternate version.

### RELATED APPLICATIONS

This application claims priority pursuant to 35 U.S.C. §119(e) to U.S. Provisional Patent Application Ser. No. 61/704,085, entitled “SYSTEM AND METHODS FOR VERSIONING HOSTED SOFTWARE”, filed on Sep. 21, 2012, the entirety of which are incorporated herein by reference as if set forth in full.

### FIELD

The present disclosure generally relates to the field of hosted systems including systems and methods for versioning hosted software.

### INTRODUCTION

Adoption of hosted and cloud computer systems for data processing needs can relieve the information technology burden and provide scalable, on-demand computing resources for an organization. However, upgrade cycles can be dependent on the computer system provider and may not follow to the needs of the organization. Typically, an upgrade to a shared computer system is provided across the board simultaneously to all users of the shared computer system.

Some organization may need to validate a data processing workflow with the new version before migrating their data processing to the new version. When an upgrade is applied across the board on the schedule of the system provided, there can be a period of time when access to the prior version is not be available and the new version has not yet been validated. Loss of the ability to process data until the workflow has been validated with the new version of the software can be detrimental to the organization, especially when revenue is dependent on the data processing activities.

From the foregoing it will be appreciated that a need exists for systems and methods that can provide control of the upgrade timing to an organization, especially when validated workflows are involved.

### DRAWINGS

For a more complete understanding of the principles disclosed herein, and the advantages thereof, reference is now made to the following descriptions taken in conjunction with the accompanying drawings, in which:

FIG. 1 is a block diagram that illustrates an exemplary computer system, in accordance with various embodiments.

FIG. 2 is a schematic diagram of an exemplary system for reconstructing a nucleic acid sequence, in accordance with various embodiments.

FIG. 3 is a schematic diagram of an exemplary versioning system, in accordance with various embodiments.

FIG. 4 is a flow diagram illustrating an exemplary method of processing data, in accordance with various embodiments.

FIG. 5 is a flow diagram illustrating an exemplary method of migrating between versions of an analysis engine, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DESCRIPTION OF VARIOUS EMBODIMENTS

In various embodiments, a system for performing validated analysis can include a management module, a first version of an analysis engine, and a second version of the analysis engine. The first version of an analysis engine configured to perform a first analysis of the data, and the second version of the analysis engine configure to perform a second analysis of the data, and the management module can be configured to receive data. The first analysis engine can be further configured to perform the first analysis as a validated analysis on the data while the second analysis is being validated against the second analysis engine. The management module can be further configured configured to perform a migration from the first analysis engine to the second analysis engine when the validation of the second analysis against the second analysis engine is complete. The second analysis engine can be further configured to perform the second analysis as the validated analysis on the data after the migration.

In particular embodiments, migration can include setting a default analysis engine to the second version of the analysis engine.

In particular embodiments, migration can include making data available to the second version of the analysis engine.

In particular embodiments, migration can include making completed reports for data processed using the first version of the analysis engine available for review within the second version of the sample analysis engine.

In particular embodiments, the first and second analyses can be performed on biological data. In an example, the biological data includes sequence information.

In various embodiments, a system for performing an analysis of biological data can include a management module, a first analysis engine, and a second analysis engine. The first analysis engine can be configured to analyze the biological data with a first instance of an analysis algorithm. The second analysis engine can be configured to analyze the biological data with a second instance of the analysis algorithm.

The management module can be configured to receive the biological data, and direct analysis of the biological data to the first analysis engine prior to validation of the second instance of the analysis algorithm and direct analysis of a validation sample to the second analysis engine when the first analysis engine is a default analysis engine. The management module can be further configured to enable a user to select the second analysis engine as the default analysis engine, and direct analysis of the biological data to the second analysis engine after the user selects the second analysis engine as the default analysis engine.

In particular embodiments, the management module can be further configured to direct analysis to the first analysis engine for a first group of users and direct analysis to a second analysis engine for a second group of users, based on a default analysis engine setting for the first and second groups of users.

In particular embodiments, reports for data processed using the first version of the analysis engine can be made available to user after the second analysis engine is selected as the default analysis engine by the user.

In particular embodiments, the biological data can include sequence information.

In various embodiments, a method can include providing a system configured to provide analysis of data using a first or a second version of an analysis engine; enabling processing of the data using a first validated analysis using the first version of the analysis engine prior to or during validation of a second analysis against the second version of the analysis engine; enabling migration from the first version of the analysis engine to the second version of the analysis engine.

In particular embodiments, migration can include setting a default analysis engine to the second version of the analysis engine.

In particular embodiments, migration can be trigged by a user of the system.

In particular embodiments, migration can include making data available to the second version of the analysis engine.

In particular embodiments, migration can include making completed reports for data processed using the first version of the analysis engine available for review within the second version of the sample analysis engine.

In particular embodiments, the method can further include enabling access to the first version of the analysis engine after the migration.

In particular embodiments, the method can further include releasing a third version of the analysis engine to the system; enabling processing of a validated analysis using either the first version or the second version of the analysis engine prior to or during validation of the analysis against the third version of the analysis engine; and enabling migration of the validated analysis to the third version of the analysis engine.

In particular embodiments, the method can further include enabling a first group of users to perform the validated analysis on the first analysis engine and enabling a second group of users to perform the validated analysis on the second analysis engine based on a migration status of the first and second groups of users.

In various embodiments, a computer implemented method can include accessing a system comprising a management module and a first version of an analysis engine; validating an analysis against the first version of a analysis engine to obtain a first validated analysis; and processing data using the first validated analysis by the first version of the analysis engine. The method can further include validating a second analysis against the second version of the analysis engine to obtain a second validated analysis; processing data using the first validated analysis by the first version of the analysis engine after the second version is available and before the validation of the second validated analysis is complete; instructing the system to migrate an account to the second version of the analysis engine after validation of the second analysis is complete; and processing data using the second validated analysis by the second version of the analysis engine after migration to the second version.

In particular embodiments, migration can include setting a default analysis engine to the second version of the analysis engine.

In particular embodiments, migration can include making data available to the second version of the analysis engine.

In particular embodiments, migration can include making completed reports for data processed using the first version of the analysis engine available for review within the second version of the sample analysis engine.

In particular embodiments, the method can further include receiving notification of a second version of the analysis engine being made available on the system.

In particular embodiments, first and second analyses can be performed on biological data. In various instances the biological data can include sequence information.

In particular embodiments, the method can further include processing data using the first validated analysis by the first version of the analysis engine for a first group of users and processing data using the second validated analysis by the second version of the analysis engine, based on a validation status of the first and second groups of users.

Embodiments of systems and methods for detecting variants are described herein.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to the temperatures, concentrations, times, number of bases, coverage, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

Further, unless otherwise required by context, singular terms shall include pluralities and plural terms shall include the singular. Generally, nomenclatures utilized in connection with, and techniques of, cell and tissue culture, molecular biology, and protein and oligo- or polynucleotide chemistry and hybridization described herein are those well known and commonly used in the art. Standard techniques are used, for example, for nucleic acid purification and preparation, chemical analysis, recombinant nucleic acid, and oligonucleotide synthesis. Enzymatic reactions and purification techniques are performed according to manufacturer's specifications or as commonly accomplished in the art or as described herein. The techniques and procedures described herein are generally performed according to conventional methods well known in the art and as described in various general and more specific references that are cited and discussed throughout the instant specification. See, e.g., Sambrook et al., Molecular Cloning: A Laboratory Manual (Third ed., Cold Spring Harbor Laboratory Press, Cold Spring Harbor, N.Y. 2000). The nomenclatures utilized in connection with, and the laboratory procedures and techniques described herein are those well known and commonly used in the art.

As used herein, “a” or “an” also may refer to “at least one” or “one or more.”

In various embodiments, a “system” sets forth a set of components, real or abstract, comprising a whole where each component interacts with or is related to at least one other component within the whole.

In various embodiments, a “biomolecule” may refer to any molecule that is produced by a biological organism, including large polymeric molecules such as proteins, polysaccharides, lipids, and nucleic acids (DNA and RNA) as well as small molecules such as primary metabolites, secondary metabolites, and other natural products.

In various embodiments, the phrase “next generation sequencing” or NGS refers to sequencing technologies having increased throughput as compared to traditional Sanger- and capillary electrophoresis-based approaches, for example with the ability to generate hundreds of thousands of relatively small sequence reads at a time. Some examples of next generation sequencing techniques include, but are not limited to, sequencing by synthesis, sequencing by ligation, and sequencing by hybridization. More specifically, the Personal Genome Machine (PGM) of Life Technologies Corp. provides massively parallel sequencing with enhanced accuracy. The PGM System and associated workflows, protocols, chemistries, etc. are described in more detail in U.S. Patent Application Publication No. 2009/0127589 and No. 2009/0026082, the entirety of each of these applications being incorporated herein by reference.

In various embodiments, the phrase “sequencing run” refers to any step or portion of a sequencing experiment performed to determine some information relating to at least one biomolecule (e.g., nucleic acid molecule).

In various embodiments, the phase “base space” refers to a representation of the sequence of nucleotides. The phase “flow space” refers to a representation of the incorporation event or non-incorporation event for a particular nucleotide flow. For example, flow space can be a series of zeros and ones representing a nucleotide incorporation event (a one, “1”) or a non-incorporation event (a zero, “0”) for that particular nucleotide flow. It should be understood that zeros and ones are convenient representations of a non-incorporation event and a nucleotide incorporation event; however, any other symbol or designation could be used alternatively to represent and/or identify these events and non-events.

In various embodiments, DNA (deoxyribonucleic acid) can be referred to as a chain of nucleotides consisting of 4 types of nucleotides; A (adenine), T (thymine), C (cytosine), and G (guanine), and that RNA (ribonucleic acid) is comprised of 4 types of nucleotides; A, U (uracil), G, and C. Certain pairs of nucleotides specifically bind to one another in a complementary fashion (called complementary base pairing). That is, adenine (A) pairs with thymine (T) (in the case of RNA, however, adenine (A) pairs with uracil (U)), and cytosine (C) pairs with guanine (G). When a first nucleic acid strand binds to a second nucleic acid strand made up of nucleotides that are complementary to those in the first strand, the two strands bind to form a double strand. In various embodiments, “nucleic acid sequencing data,” “nucleic acid sequencing information,” “nucleic acid sequence,” “genomic sequence,” “genetic sequence,” or “fragment sequence,” or “nucleic acid sequencing read” denotes any information or data that is indicative of the order of the nucleotide bases (e.g., adenine, guanine, cytosine, and thymine/uracil) in a molecule (e.g., whole genome, whole transcriptome, exome, oligonucleotide, polynucleotide, fragment, etc.) of DNA or RNA. It should be understood that the present teachings contemplate sequence information obtained using all available varieties of techniques, platforms or technologies, including, but not limited to: capillary electrophoresis, microarrays, ligation-based systems, polymerase-based systems, hybridization-based systems, direct or indirect nucleotide identification systems, pyrosequencing, ion- or pH-based detection systems, electronic signature-based systems, etc.

In various embodiments, a “polynucleotide”, “nucleic acid”, or “oligonucleotide” refers to a linear polymer of nucleosides (including deoxyribonucleosides, ribonucleosides, or analogs thereof) joined by internucleosidic linkages. Typically, a polynucleotide comprises at least three nucleosides. Usually oligonucleotides range in size from a few monomeric units, e.g. 3-4, to several hundreds of monomeric units. Whenever a polynucleotide such as an oligonucleotide is represented by a sequence of letters, such as “ATGCCTG,” it will be understood that the nucleotides are in 5′->3′ order from left to right and that “A” denotes deoxyadenosine, “C” denotes deoxycytidine, “G” denotes deoxyguanosine, and “T” denotes thymidine, unless otherwise noted. The letters A, C, G, and T may be used to refer to the bases themselves, to nucleosides, or to nucleotides comprising the bases, as is standard in the art.

The techniques of “paired-end,” “pairwise,” “paired tag,” or “mate pair” sequencing are generally known in the art of molecular biology (Siegel A. F. et al., Genomics. 2000, 68: 237-246; Roach J. C. et al., Genomics. 1995, 26: 345-353). These sequencing techniques provide for the determination of multiple “reads” of sequence information from different regions on a polynucleotide strand. Typically, the distance, such as an insert region or a gap, between the reads or other information regarding a relationship between the reads is known or can be approximated. In some situations, these sequencing techniques provide more information than does sequencing stretches of nucleic acid sequences in a random fashion. With the use of appropriate software tools for the assembly of sequence information (e.g., Millikin S. C. et al., Genome Res. 2003, 13: 81-90; Kent, W. J. et al., Genome Res. 2001, 11: 1541-8) it is possible to make use of the knowledge that the “paired-end,” “pairwise,” “paired tag” or “mate pair” sequences are not completely random, but are known or anticipated to occur some distance apart and/or to have some other relationship, and are therefore linked or paired with respect to their position within the genome. This information can aid in the assembly of whole nucleic acid sequences into a consensus sequence.

### Computer-Implemented System

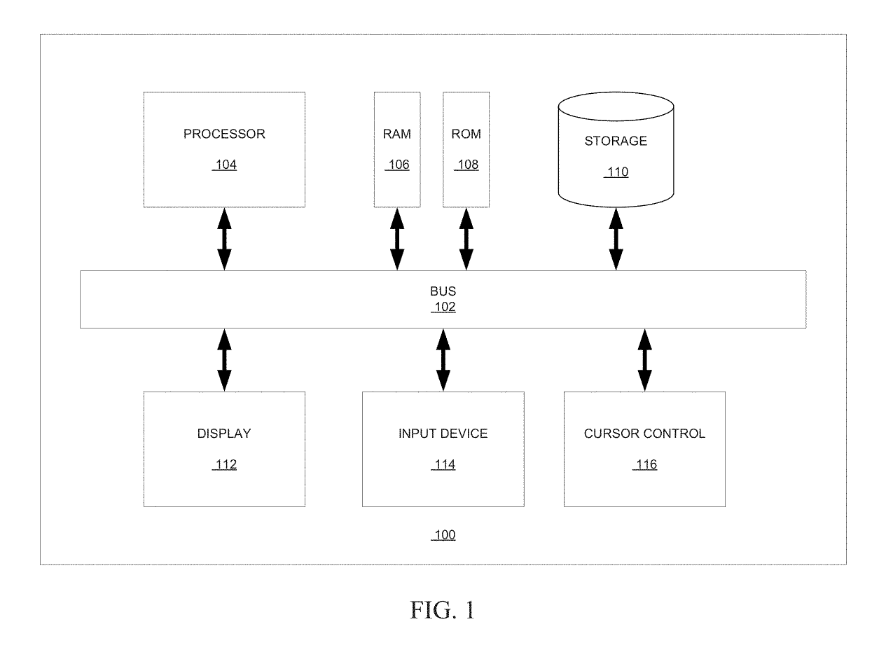

FIG. 1 is a block diagram that illustrates a computer system 100, upon which embodiments of the present teachings may be implemented. In various embodiments, computer system 100 can include a bus 102 or other communication mechanism for communicating information, and a processor 104 coupled with bus 102 for processing information. In various embodiments, computer system 100 can also include a memory 106, which can be a random access memory (RAM) or other dynamic storage device, coupled to bus 102 for determining base calls, and instructions to be executed by processor 104. Memory 106 also can be used for storing temporary variables or other intermediate information during execution of instructions to be executed by processor 104. In various embodiments, computer system 100 can further include a read only memory (ROM) 108 or other static storage device coupled to bus 102 for storing static information and instructions for processor 104. A storage device 110, such as a magnetic disk or optical disk, can be provided and coupled to bus 102 for storing information and instructions.

In various embodiments, computer system 100 can be coupled via bus 102 to a display 112, such as a cathode ray tube (CRT) or liquid crystal display (LCD), for displaying information to a computer user. An input device 114, including alphanumeric and other keys, can be coupled to bus 102 for communicating information and command selections to processor 104. Another type of user input device is a cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results can be provided by computer system 100 in response to processor 104 executing one or more sequences of one or more instructions contained in memory 106. Such instructions can be read into memory 106 from another computer-readable medium, such as storage device 110. Execution of the sequences of instructions contained in memory 106 can cause processor 104 to perform the processes described herein. Alternatively hard-wired circuitry can be used in place of or in combination with software instructions to implement the present teachings. Thus implementations of the present teachings are not limited to any specific combination of hardware circuitry and software.

In various embodiments, the term “computer-readable medium” as used herein refers to any media that participates in providing instructions to processor 104 for execution. Such a medium can take many forms, including but not limited to, non-volatile media, volatile media, and transmission media. Examples of non-volatile media can include, but are not limited to, optical or magnetic disks, such as storage device 110. Examples of volatile media can include, but are not limited to, dynamic memory, such as memory 106. Examples of transmission media can include, but are not limited to, coaxial cables, copper wire, and fiber optics, including the wires that comprise bus 102.

Common forms of non-transitory computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

### Nucleic Acid Sequencing Platforms

Nucleic acid sequence data can be generated using various techniques, platforms or technologies, including, but not limited to: capillary electrophoresis, microarrays, ligation-based systems, polymerase-based systems, hybridization-based systems, direct or indirect nucleotide identification systems, pyrosequencing, ion- or pH-based detection systems, electronic signature-based systems, etc.

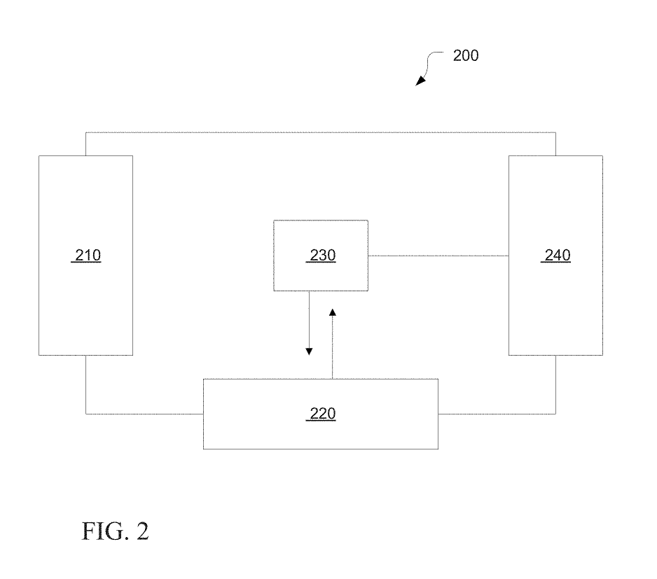

Various embodiments of nucleic acid sequencing platforms, such as a nucleic acid sequencer, can include components as displayed in the block diagram of FIG. 2. According to various embodiments, sequencing instrument 200 can include a fluidic delivery and control unit 202, a sample processing unit 204, a signal detection unit 206, and a data acquisition, analysis and control unit 208. Various embodiments of instrumentation, reagents, libraries and methods used for next generation sequencing are described in U.S. Patent Application Publication No. 2009/0127589 and No. 2009/0026082 are incorporated herein by reference. Various embodiments of instrument 200 can provide for automated sequencing that can be used to gather sequence information from a plurality of sequences in parallel, such as substantially simultaneously.

In various embodiments, the fluidics delivery and control unit 202 can include reagent delivery system. The reagent delivery system can include a reagent reservoir for the storage of various reagents. The reagents can include RNA-based primers, forward/reverse DNA primers, oligonucleotide mixtures for ligation sequencing, nucleotide mixtures for sequencing-by-synthesis, optional ECC oligonucleotide mixtures, buffers, wash reagents, blocking reagent, stripping reagents, and the like. Additionally, the reagent delivery system can include a pipetting system or a continuous flow system which connects the sample processing unit with the reagent reservoir.

In various embodiments, the sample processing unit 204 can include a sample chamber, such as flow cell, a substrate, a micro-array, a multi-well tray, or the like. The sample processing unit 204 can include multiple lanes, multiple channels, multiple wells, or other means of processing multiple sample sets substantially simultaneously. Additionally, the sample processing unit can include multiple sample chambers to enable processing of multiple runs simultaneously. In particular embodiments, the system can perform signal detection on one sample chamber while substantially simultaneously processing another sample chamber. Additionally, the sample processing unit can include an automation system for moving or manipulating the sample chamber.

In various embodiments, the signal detection unit 206 can include an imaging or detection sensor. For example, the imaging or detection sensor can include a CCD, a CMOS, an ion or chemical sensor, such as an ion sensitive layer overlying a CMOS or FET, a current or voltage detector, or the like. The signal detection unit 206 can include an excitation system to cause a probe, such as a fluorescent dye, to emit a signal. The excitation system can include an illumination source, such as arc lamp, a laser, a light emitting diode (LED), or the like. In particular embodiments, the signal detection unit 206 can include optics for the transmission of light from an illumination source to the sample or from the sample to the imaging or detection sensor. Alternatively, the signal detection unit 206 may provide for electronic or non-photon based methods for detection and consequently not include an illumination source. In various embodiments, electronic-based signal detection may occur when a detectable signal or species is produced during a sequencing reaction. For example, a signal can be produced by the interaction of a released byproduct or moiety, such as a released ion, such as a hydrogen ion, interacting with an ion or chemical sensitive layer. In other embodiments a detectable signal may arise as a result of an enzymatic cascade such as used in pyrosequencing (see, for example, U.S. Patent Application Publication No. 2009/0325145, the entirety of which being incorporated herein by reference) where pyrophosphate is generated through base incorporation by a polymerase which further reacts with ATP sulfurylase to generate ATP in the presence of adenosine 5′ phosphosulfate wherein the ATP generated may be consumed in a luciferase mediated reaction to generate a chemiluminescent signal. In another example, changes in an electrical current can be detected as a nucleic acid passes through a nanopore without the need for an illumination source.

In various embodiments, a data acquisition analysis and control unit 208 can monitor various system parameters. The system parameters can include temperature of various portions of instrument 200, such as sample processing unit or reagent reservoirs, volumes of various reagents, the status of various system subcomponents, such as a manipulator, a stepper motor, a pump, or the like, or any combination thereof.

It will be appreciated by one skilled in the art that various embodiments of instrument 200 can be used to practice variety of sequencing methods including ligation-based methods, sequencing by synthesis, single molecule methods, nanopore sequencing, and other sequencing techniques.

In various embodiments, the sequencing instrument 200 can determine the sequence of a nucleic acid, such as a polynucleotide or an oligonucleotide. The nucleic acid can include DNA or RNA, and can be single stranded, such as ssDNA and RNA, or double stranded, such as dsDNA or a RNA/cDNA pair. In various embodiments, the nucleic acid can include or be derived from a fragment library, a mate pair library, a ChIP fragment, or the like. In particular embodiments, the sequencing instrument 200 can obtain the sequence information from a single nucleic acid molecule or from a group of substantially identical nucleic acid molecules.

In various embodiments, sequencing instrument 200 can output nucleic acid sequencing read data in a variety of different output data file types/formats, including, but not limited to: *.fasta, *.csfasta, *seq.txt, *qseq.txt, *.fastq, *.sff, *prb.txt, *.sms, *srs and/or *.qv.

### System and Methods for Data Analysis

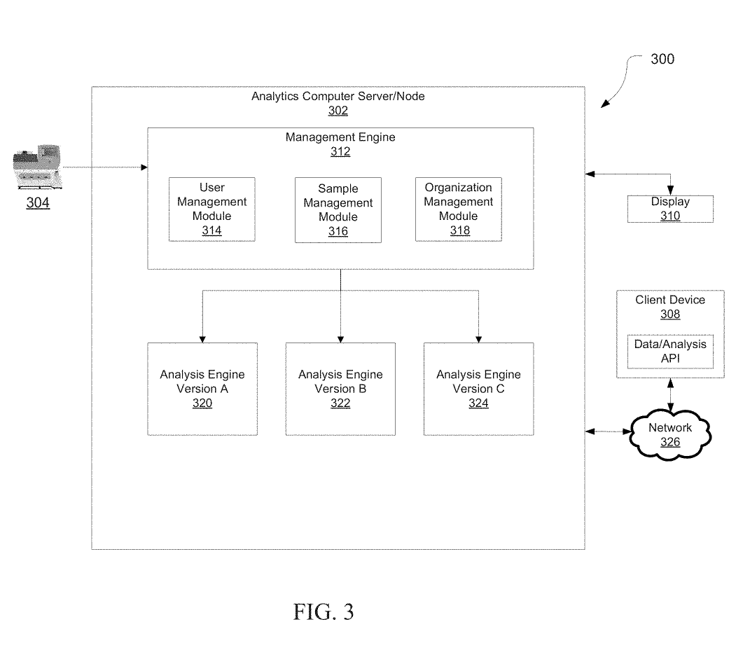

FIG. 3 is a schematic diagram of a system for an analysis system, in accordance with various embodiments.

As depicted herein, analysis system 300 can include a data collection device 304, such as a nucleic acid sequence analysis device 304 (e.g., nucleic acid sequencer, real-time/digital/quantitative PCR instrument, microarray scanner, etc.), an analytics computing server/node/device 302, and a display 310 and/or a client device terminal 308. In other embodiments, the data collection device 304 can be an instrument for collecting biological data, such as an rtPCR, a digital PCR, a microarray, or the like. In other embodiments, instrument can collect data unrelated to a clinical or biological sample, such as weather data, geological data, topological data, particle physics data, astronomical data, or the like.

In various embodiments, analytics computing device 302 can be a hosted or cloud based system that provides data analysis for multiple organizations and users. Analytics computing device 302 can segregate access to data and workflows to an individual organization, allowing only users within an organization access to the data and workflows.

In various embodiments, the analytics computing sever/node/device 302 can be communicatively connected to the data collection device 304, and client device terminal 308 via a network connection 324 that can be either a “hardwired” physical network connection (e.g., Internet, LAN, WAN, VPN, etc.) or a wireless network connection (e.g., Wi-Fi, WLAN, etc.).

In various embodiments, the analytics computing device/server/node 302 can be a workstation, mainframe computer, distributed computing node (part of a “cloud computing” or distributed networking system), personal computer, mobile device, etc. In various embodiments, the data collection device 304 can be a nucleic acid sequencer, real-time/digital/quantitative PCR instrument, microarray scanner, etc. It should be understood, however, that the data collection device 304 can essentially be any type of instrument that can generate data from samples obtained from an individual.

The analytics computing server/node/device 302 can be configured to host a management engine 312 and multiple versions of a variant analysis engine 320, 322, and 324. Management engine 312 can include a user management module 314, a data management module 316, and an organization management module 318.

Organization management module 318 can be configured to maintain organizational information, such as identification information, organization wide preferences and settings, and the like. Data management module 316 can be configured to maintain sample information, such as the sample data, identification information, classification information, an affiliation with an organization, and the like. User management module 314 can be configured to maintain user information, such as identification information, classification information, an affiliation with an organization, and the like.

Management Engine 312 can be configured to provide user interfaces for user login, tracking a stage of analysis for a sample, transitioning a user or organization between versions of analysis engines. In various embodiments, migration can involve changing an organization level setting that controls a default version of the analysis engine. Further, migration may involve reconfiguring data and results to be available for the newer analysis engine. In various embodiments, reconfiguring may involve adding fields to a data store, converting to a new binary storage format, compressing the data using a new compression algorithm, or the like. Generally, reconfiguring does not affect the integrity of the data or alter the information content.

Analysis engines 320, 322, and 324 represent various versions of an analysis engine. As such, analysis engines 320, 322, and 324 can be configured to perform similar analyses of sample data, but may offer different features, utilize different algorithms, have different standard settings, and other differences. In various embodiments, analysis engines 320, 322, and 324 can be configured to perform an analysis of biological data, such as analyzing sequence information. In other embodiments, analysis engines 320, 322, and 324 can be configured to perform an analysis on data related to particle physics, weather forecasting, climate modeling, astronomy, geology, oceanographic modeling, or the like.

In various embodiments, a workflow for analyzing a class of data may be a validated workflow. For example, analysis of clinical data may require a validated workflow to ensure the data processing produces a desired result in which errors, such as false positives or false negatives, are minimized and understood.

In various embodiments, transitioning analysis engine 320 to analysis engine 322, can require revalidating a workflow with analysis engine 322 prior to processing data using analysis engine 322. As such, analytics system 300 can provide access to a previously validated workflow using analysis engine 320, while providing access to analysis engine 322 for revalidating the workflow. In various embodiments, users with a responsibility for analyzing clinical samples can be restricted to using analysis engine 320 while users with a responsibility for revalidating the workflow may have access to analysis engine 322.

Further, in a hosted system that is available for use by multiple organizations, each organization may desire to transition between analysis engines at different times, depending on the validation needs and schedules of individual organizations. As such, analysitics computing device 302 can provide access to multiple versions of the analysis engine on a schedule that allows organizations to migrate to newer versions according to the needs of the organization rather than the upgrade cycle of the system provider.

Client device 308 can be a thin client or thick client computing device. In various embodiments, client terminal 308 can have a web browser (e.g., INTERNET EXPLORER™, FIREFOX™, SAFARI™, etc) that can be used to communicate information to and/or control the operation of the pre-processing module 312, mapping module 314, realignment engine 318, variant calling engine 320, and post processing engine 322 using a browser to control their function. For example, the client terminal 308 can be used to configure the operating parameters (e.g., match scoring parameters, annotations parameters, filtering parameters, data security and retention parameters, etc.) of the various modules, depending on the requirements of the particular application. Similarly, client terminal 308 can also be configure to display the results of the analysis performed by the variant calling module 316 and the nucleic acid sequencer 304.

It should be understood that the various data stores disclosed as part of system 300 can represent hardware-based storage devices (e.g., hard drive, flash memory, RAM, ROM, network attached storage, etc.) or instantiations of a database stored on a standalone or networked computing device(s).

It should also be appreciated that the various data stores and modules/engines shown as being part of the system 300 can be combined or collapsed into a single module/engine/data store, depending on the requirements of the particular application or system architecture. Moreover, in various embodiments, the system 300 can comprise additional modules, engines, components or data stores as needed by the particular application or system architecture.

In various embodiments, the system 300 can be configured to process the nucleic acid reads in color space. In various embodiments, system 300 can be configured to process the nucleic acid reads in base space. In various embodiments, system 300 can be configured to process the nucleic acid sequence reads in flow space. It should be understood, however, that the system 300 disclosed herein can process or analyze nucleic acid sequence data in any schema or format as long as the schema or format can convey the base identity and position of the nucleic acid sequence.

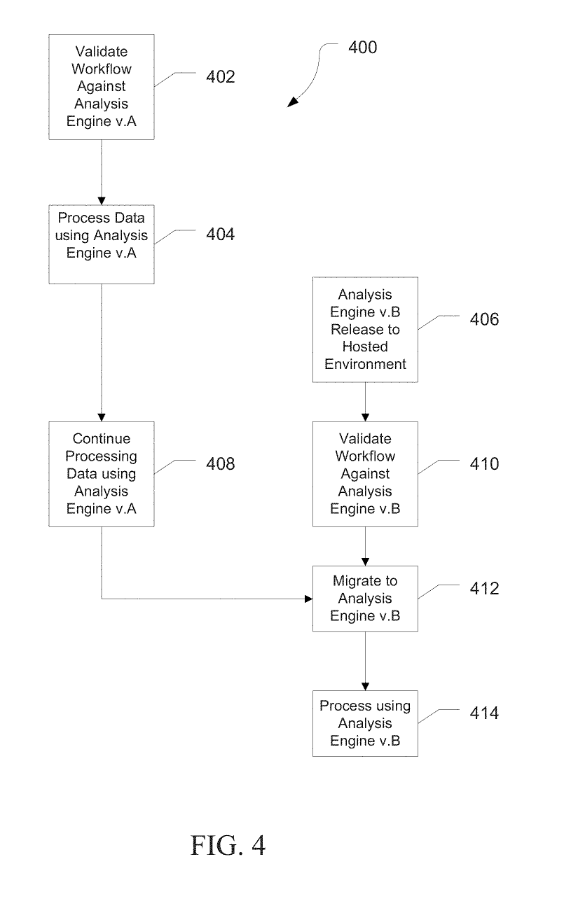

FIG. 4 is an exemplary flow diagram showing a method 400 for processing data using a validated workflow, in accordance with various embodiments. At 402, a workflow can be validated using version A of an analysis engine within a hosted environment. The hosted environment can provide access to computing resources shared by multiple users across multiple organizations. The hosted environment can be maintained by a group that is separate from the users and organizations that use the computing resources. As such, the users may not have control over an upgrade cycle of the analysis engine.

In various embodiments, validation may involve analyzing a validation data set using the workflow and comparing the result to an expected result for the validation data set. For example, the validation data set may be an artificial data set constructed to produce the expected result or the validation data set can be a well characterized data set in which the expected result is obtained using other methods of analysis. Further, validation may involve analyzing more than one validation data set. Validation may involve insuring that the result matches the expected result, or that the number of differences between the result and the expected result are limited. When there are differences between the result and the expected result, characterizing the differences may provide insights in how to interpret the results produced by the workflow.

At 404, experimental data can be analyzed using version A of the analysis engine to perform the validated workflow. In various embodiments, the experimental data can represent samples for which the result is not yet known. For example, the experimental data can represent sequence data from a clinical sample for a patient, and the results may be useful in diagnosing the patient or selecting a treatment for the patient. As such, the analysis needs to be performed on a validated workflow to ensure the accuracy of the results.

At 406, version B of the analysis engine can be released to the hosted environment. After the release of version B of the analysis engine, users and organizations that are not yet ready to process data using version B can continue to process data using version A of the analysis engine, as illustrated at 408. Users and organizations may continue to use version A when they have not yet validated version B or when their upgrade cycle does not match the upgrade cycle of the provider of the hosted environment. For example, an organization that updates their data processing on an annual basis may not want to migrate to each new version of the analysis engine when the hosted environment is upgraded every six months.

At 410, validation of the workflow can be performed for version B of the analysis engine, and at 412, a user or organization can migrate to the version B of the analysis engine after validation has been completed. After migration, new data can be processed using version B of the analysis engine. Additionally, data previously processed using version A of the analysis engine can be reprocessed using version B of the analysis engine if desired.

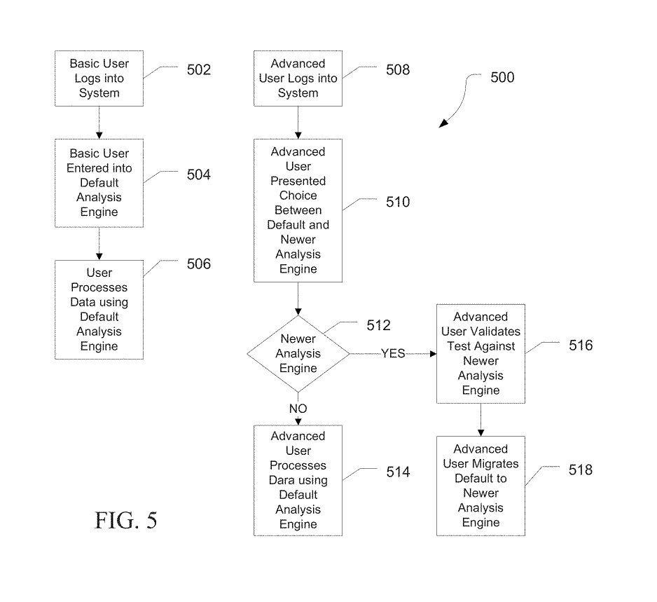

FIG. 5 is an exemplary flow diagram showing a method 400 for migrating between versions of an analysis engine, in accordance with various embodiments. At 502, a basic user can log into the system. In various embodiments, the basic user can be a user tasked with analyzing data using a validated workflow. At 504, upon logon, the basic user can be provided access to a default analysis engine. The default analysis engine can be a version of the analysis engine that has been accepted and approved for use by an organization to which the basic user belongs. At 506, the basic user can process data using a validated workflow with the default analysis engine.

At 508, an advanced user can log into the system. The advanced user can be a user with the responsibility to validate, accept, or approve new versions of the analysis engine. The advanced user may also have the need to analyze data using the validated workflow. As such, at 510, the advanced user can, upon login, be presented with an interface to select which version of the analysis engine to access. For example, the advanced user may select between the default analysis engine for analyzing data using the validated workflow or a newer version of the analysis engine for validation of the workflow on the new version.

At 512, the advanced user can make a selection. When the advanced user selects the default analysis engine, the advanced user can process data using the validated workflow on the default analysis engine, as illustrated in 514.

Alternatively, when the advanced user selects the newer version of the analysis engine, at 516, the advanced user can validated the workflow against the newer version of the analysis engine. Further, at 518, upon completion and acceptance of the validation results, the advanced user can migrate the default to the newer version of the analysis engine. Migration to the newer version of the analysis engine can involve setting an organization wide default analysis engine setting to point to the newer version of the analysis engine. Additionally, migration may involve configuring data and results to be accessible using the newer version of the analysis engine. In various embodiments, the prior version of the analysis engine can be available after migration to have access to ongoing analyses that were initiated under the prior version of the analysis engine.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

The embodiments described herein, can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations that form part of the embodiments described herein are useful machine operations. The embodiments, described herein, also relate to a device or an apparatus for performing these operations. The systems and methods described herein can be specially constructed for the required purposes or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

What is claimed is:

1. A system for performing an analysis of biological data, comprising:
a management module configured to receive data;
a first analysis engine configured to analyze the biological data with a first instance of an analysis algorithm; and
a second analysis engine configure to analyze the biological data with a second instance of the analysis algorithm;
wherein the management module is further configured to:
direct analysis of the biological data to the first analysis engine prior to validation of the second instance of the analysis algorithm and direct analysis of a validation sample to the second analysis engine when the first analysis engine is a default analysis engine; and
enable a user to select the second analysis engine as the default analysis engine;
direct analysis of the biological data to the second analysis engine after the user selects the second analysis engine as the default analysis engine.

2. The system of claim 1, wherein the management module is further configured to direct analysis to the first analysis engine for a first group of users and direct analysis to a second analysis engine for a second group of users, based on a default analysis engine setting for the first and second groups of users.

3. The system of claim 1, wherein completed reports for data processed using the first version of the analysis engine are available to user after the second analysis engine is selected as the default analysis engine by the user.

4. The system of claim 1, wherein the biological data includes sequence information.

5. A method, comprising:
providing a system configured to provide analysis of data using a first or a second version of an analysis engine;
enabling processing of the data using a first validated analysis using the first version of the analysis engine prior to or during validation of a second analysis against the second version of the analysis engine;
enabling migration from the first version of the analysis engine to the second version of the analysis engine.

6. The method of claim 5, wherein migration includes setting a default analysis engine to the second version of the analysis engine.

7. The method of claim 5, wherein migration is trigged by a user of the system.

8. The method of claim 5, wherein migration includes making data available to the second version of the analysis engine.

9. The method of claim 5, wherein migration includes making completed reports for data processed using the first version of the analysis engine available for review within the second version of the sample analysis engine.

10. The method of claim 5, further comprising enabling access to the first version of the analysis engine after the migration.

11. The method of claim 5, further comprising:
releasing a third version of the analysis engine to the system;
enabling processing of a validated analysis using either the first version or the second version of the analysis engine prior to or during validation of the analysis against the third version of the analysis engine;
enabling migration of the validated analysis to the third version of the analysis engine.

12. The method of claim 5, further comprising enabling a first group of users to perform the validated analysis on the first analysis engine and enabling a second group of users to perform the validated analysis on the second analysis engine based on a migration status of the first and second groups of users.

13. A computer implemented method, comprising:
accessing a system comprising a management module and a first version of an analysis engine;
validating an analysis against the first version of a analysis engine to obtain a first validated analysis;
processing data using the first validated analysis by the first version of the analysis engine;
validating a second analysis against the second version of the analysis engine to obtain a second validated analysis;
processing data using the first validated analysis by the first version of the analysis engine after the second version is available and before the validation of the second validated analysis is complete;
instructing the system to migrate an account to the second version of the analysis engine after validation of the second analysis is complete; and
processing data using the second validated analysis by the second version of the analysis engine after migration to the second version.

14. The method of claim 13, wherein migration includes setting a default analysis engine to the second version of the analysis engine.

15. The method of claim 13, wherein migration includes making data available to the second version of the analysis engine.

16. The method of claim 13, wherein migration includes making completed reports for data processed using the first version of the analysis engine available for review within the second version of the sample analysis engine.

17. The method of claim 13, further comprising receiving notification of a second version of the analysis engine being made available on the system.

18. The method of claim 13, wherein the first and second analyses are performed on biological data.

19. The method of claim 18, wherein the biological data includes sequence information.

20. The method of claim 13, further comprising processing data using the first validated analysis by the first version of the analysis engine for a first group of users and processing data using the second validated analysis by the second version of the analysis engine, based on a validation status of the first and second groups of users.
